(19) United States
(12) Patent Application Publication
(10) Pub. No.: US 2001/0030612 A1
(43) Pub. Date: Oct. 18, 2001

(54) Remotely activated novelty device

(76) Inventors: Tom Kerber, Stoney Creek (CA); Ralph Beaver, Tampa, FL (US)

Correspondence Address: Roger A. Heppermann, Marshall, O'Toole, Gerstein, Murray & Borun, 6300 Sears Tower, 233 South Wacker Drive, Chicago, IL, 60606-6402, US

(21) Appl. No.: 09/742,874

(22) Filed: Dec. 20, 2000

Related U.S. Application Data
(60) Provisional application No. 60/171,435, filed on Dec. 22, 1999.

(51) Int. Cl. G08C 19/00

(52) U.S. Cl. 340/825.69; 340/3.1

(57) ABSTRACT

A novelty device, which may be portable and connected to an article of clothing, includes an antenna that receives an operating signal carrying an activation command. A receiver within the novelty device is coupled to the antenna and demodulates the modulated operating signal to produce an operating signal, which in turn, is decoded by a decoder to detect the presence or absence of the activation command. An operator-controlled signal source sends an activation command to a transmitting unit, which in turn, modulates the activation command to provide a modulated operating signal to one or more novelty devices via an over-the-air channel. When the decoder detects the presence of the activation command, the decoder operates a switch to activate an indicator, which may produce lights, emit sounds, or perform some mechanical action or any other visual or audio effect. To activate the novelty device, in this manner, a plurality of remotely activated novelty devices may be simultaneously activated before, during, or after an occurrence of an event or an activity by a centralized operator, such as an announcer at a sporting event, someone watching the sporting event via television, a computer, etc., to produce an interesting effect. The indicators may be deactivated after a specific period of time, or when the decoders detect the absence of an activation command or the presence of an activation command to deactivate the novelty devices.

### CROSS REFERENCE TO RELATED APPLICATION

This application is a non-provisional application claiming priority from Provisional Application Ser. No. 60/171,435, entitled “Remotely Activated Novelty Device” filed Dec. 22, 1999.

### TECHNICAL FIELD

The present invention relates generally to novelty devices and, more particularly, to a novelty device and a method of activating a novelty device.

### BACKGROUND ART

People at sporting events, concerts, etc. usually indicate an occurrence of an event or an activity by some sort of gesture such as clapping, yelling, standing, etc. In fact, a group of people or even an entire stadium filled with people may synchronously participate in physical or verbal acts to acknowledge an occurrence of an event or an activity such as the scoring of a goal, a run, a touchdown, etc. Extreme sports fans may paint themselves with the letters of a home team's name for a football game while other spectators may synchronously stand up and raise their arms to create a wave around the entire stadium to indicate the start of a game or a score by the home team. Likewise, spectators at a concert may raise their arms and sway from side to side to indicate the entrance of a band or the beginning of a song.

Spectators are sometimes provided with novelty items by sponsors of events or activities. Such items are mostly for promotional purposes and typically include a sponsor's name, logo or trademark. For example, political candidates provide buttons for supporters at fund-raisers, rallies or any other political campaign functions throughout their campaign trails. The novelty items may be also showcased or displayed during a sporting event or a concert to indicate an occurrence of an event or an activity. For example, attendants of a concert may be asked to hold up candles or lighting devices before a band enters the stage. Similarly, after each basket made by a particular basketball player on a team, the spectators of a professional basketball game may be asked to raise signs with a sponsoring shoe company's logo on it for promotional purposes. While signs made from cardboard or paper are more cost effective, other sponsors have distributed articles of clothing such as shirts, baseball caps, hats, pins or buttons with the sponsoring company's logo or trademark thereon to promote the company before, during or after the activity. Alternatively, some sponsors have distributed user activated electronic devices that flash lights, such as light emitting diodes (LEDs), or that emit sounds. Such electronic devices, however, must be activated manually and individually by each person wearing or holding a device. As a result, these devices are not automatically synchronized to activate before, during or after an occurrence of an event or an activity.

### SUMMARY OF INVENTION

The present invention provides a remotely activated novelty device that may, for example, utilize simple and inexpensive components to indicate an occurrence of an event or an activity. The novelty device, which may be portable, may be connected to an article of clothing such as, but not limited to, a shirt, a baseball cap, a hat, a pin or a button. Remote activation of the novelty device may be used to indicate an event or an activity such as the scoring of a goal, a run or a touchdown at a sporting event, the introduction of a band at a concert, or any other desired activity. The novelty device may indicate an occurrence of an event or an activity by, for example, producing lights, sounds, mechanical actions, or any other audio or visual effect.

In one embodiment, a signal source provides an activation command, which may activate or deactivate the novelty device, to a transmitting unit that includes a transmitter having a modulator coupled to an antenna. The transmitting unit then sends a modulated operating signal, which may carry the activation command, through an over-the-air channel to be received by one or more novelty devices. The novelty devices, each of which includes an antenna, a receiver, a decoder, a switch, and an indicator, receive the modulated operating signal via the over-the-air channel. The receiver demodulates the modulated operating signal to produce an operating signal. The decoder then decodes the operating signal to detect the presence or absence of an activation command. When the decoder detects the presence of the activation command to turn on the indicator, the decoder operates a switch to activate the indicator which may, for example, produce a light, emit a sound, perform some mechanical action or any other visual or audio effect. When multiple remotely activated novelty devices are located in close proximity, such as at a sporting event, they may be activated simultaneously thereby producing an interesting effect. The novelty devices may be activated for a specific period of time, or until the decoder detects the absence of an activation command or the presence of an activation command to deactivate the novelty devices.

Other aspects and advantages of the present invention will become apparent upon consideration of the following drawing, and detailed description of the preferred embodiment.

### BRIEF DESCRIPTION OF THE DRAWINGS

FIG. 1 is a flow diagram of a system for remotely activating a novelty device;

FIG. 2 is a block diagram of a system for remotely activating a novelty device;

FIG. 3 is a block diagram of a transmitting unit associated with the remotely activated novelty device of FIG. 2;

FIG. 4 is a block diagram of a remotely activated novelty device; and

FIG. 5 is a circuit schematic diagram of one embodiment of the remotely activated novelty device of FIG. 4.

### DETAILED DESCRIPTION OF THE PREFERRED EMBODIMENT

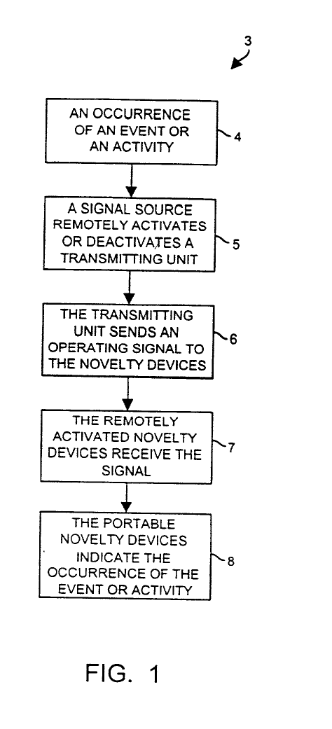

As illustrated by the flow diagram 3 of FIG. 1, a novelty device may be remotely activated or deactivated to indicate an occurrence of an event such as the scoring of a goal, a run, or a touchdown at a sporting event, the introduction of an important person, such as at a concert, on a rally or any other desired activity. Upon the occurrence of any desired event 4, a signal source activates a transmitting unit 5, which in turn, sends an operating signal to a plurality of novelty devices 6. The remotely activated novelty devices receive the operating signal sent from the transmitting unit 7, decode that signal if necessary, and indicate the occurrence of the event or the activity by producing lights, emitting sounds, or performing some mechanical action or any other visual or audio effect 8. The remotely activated novelty devices may be activated for a specific period of time, or may be deactivated by a centralized operator such as, but not limited to, a person or a central processing unit. If desired, a person, such as a broadcaster or other event personnel may cause the operating signal to be provided to the transmitting unit upon the occurrence of an event or, alternatively, the operating signal may be automatically sent, such as when the goal light of a hockey game goes off, when a score is posted on a scoreboard, etc.

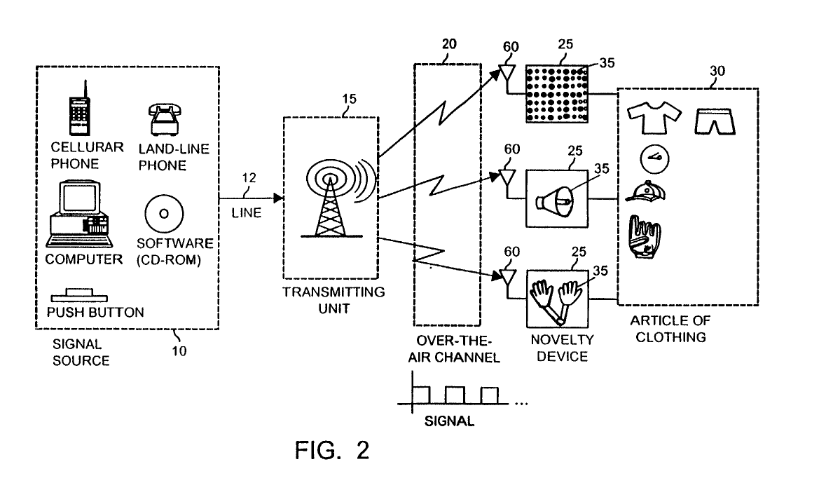

Referring now to FIG. 2, a signal source 10 is coupled to a line 12 to establish a connection with a transmitting unit 15, which communicates through an over-the-air channel 20 to one or more remotely activated novelty devices 25 connected to, for example, articles of clothing 30. The signal source 10, which may be any desired type of signal source that provides any type of signal (e.g., an analog signal, a digital signal like a bit-pattern, telephone tone signal, etc.), sends an activation command to the transmitting unit 15. The transmitting unit 15 modulates the activation command to produce a modulated operating signal and sends this modulated operating signal through the over-the-air channel 20 to one or more of the novelty devices 25. The signal source 10 may include, but is not limited to, an oscillator, a cellular phone, a land-line phone, a one push-button controlled signal source or any other computer telephony integration technology or hardwired device, controlled by, for example, a centralized operator. The activation command provided by the signal source 10 may thus be, but is not limited to, an analog signal, a digital signal, a combined analog-digital signal, a bit-pattern code, etc. In one example, a cellular phone may send a digital telephone tone signal, or a computer may send a bit-pattern code as the activation command to the transmitting unit 15 to send the activation command. An operator may press a key on a cellular phone or a key on a computer keyboard of a computer, or press any other type of switch to provide the activation command to the transmitting unit 15. Alternatively, a computer programmed by software may provide the activation command to the transmitting unit 15. For example, the computer may automatically provide the activation command to the transmitting unit 15 at the end of a period or a quarter of a sporting event.

The transmitting unit 15 receives the activation command through the line 12 and produces a modulated operating signal in any desired form. In a simple case, the transmitting unit 15 may simply transmit the activation command as an operating signal. In more complex situations, the transmitting unit 15 may modulate the activation command onto a carrier signal to produce a modulated operating signal and transmit the modulated operating signal through the over-the-air channel 20. For the purpose of the discussion, the activation command sent by the transmitting unit 15 is considered to be a modulated operating signal whether or not it is modulated onto a carrier wave. In any event, the modulated operating signal carries the activation command through the over-the-air channel 20 to one or more of the novelty devices 25.

The remotely activated novelty devices 25 receive and decode the modulated operating signal and, based on the presence of an appropriate activation command, activate the indicators 35. For example, if the modulated operating signal carries the activation command to activate the novelty devices 25, then the novelty devices 25 activate the indicators 35. Accordingly, if the novelty devices 25 receive a modulated operating signal without the activation command to activate the novelty devices 25 or a modulated operating signal carrying an activation command to deactivate the novelty devices 25, then the novelty devices 25 may deactivate the associated indicators 35. The indicators 35 may include, but are not limited to, light emitting diodes (LEDs), fiber optics or other lighting devices, speakers or mechanical devices. As indicated above, the remotely activated novelty devices 25 may be connected to any stationary or movable product, or any article of clothing 30 such as shirts, baseball caps, hats, pins, and buttons to indicate an occurrence of an event or an activity. For example, baseball caps with the remotely activated novelty device 25 may be sold or given away to spectators at a baseball game. After an occurrence of an event or an activity such as a home run or a strike out, the centralized operator, such as the game's broadcaster or some other broadcaster, or someone watching the game via a television, a computer, etc., may send an activation command by activating the signal source 10, to provide an activation command through the line 12 to the transmitting unit 15. If desired, a computer may be programmed by software to automatically provide the activation command to the transmitting unit 15 after the home run or the strike out, or any other desired activity. The transmitting unit 15 may modulate the activation command and send the modulated operating signal, which carries the activation command, to a plurality of remotely activated novelty devices 25 connected to the baseball caps that were bought by or distributed to the spectators before the game. Upon receiving the modulated operating signal, the novelty devices 25 decode the signal to detect the presence of the activation command. When the activation command is detected, the novelty devices operate a switch to activate the indicators 35. Similarly, buttons with the remotely activated novelty devices 25 may be distributed to supporters of a political candidate at fund-raisers, rallies or any other political functions for his or her campaign. In this example, a centralized operator may remotely activate the novelty devices 25 with a cellular phone or any other signal source 10, such as those mentioned above, to introduce the political candidate as he or she enters a stage.

When multiple novelty devices 25 detect the activation command, the indicators 35 are activated simultaneously to produce an interesting effect. The indicators 35 may activate lights, emit sounds, or perform some mechanical action or any other visual or audio effect. For example, the indicators 35 may display “HR” for home run with LEDs, announce “SCORE!!!” with speakers, clap with mechanical hands, etc. Similarly, the indicators 35 may display or announce a political candidate's name to introduce the candidate during a fund-raiser, a rally or any other political campaign functions. The indicators 35 may be activated until the novelty devices 25 detect the absence of the activation command, until a time-out period has expired, or until the presence of the activation command to deactivate the novelty devices 25 is detected. For example, the centralized operator may send the activation command to the transmitting unit 15 by pushing a button or a key to deactivate the novelty devices 25. In such a configuration, the centralized operator may send the activation command to activate the novelty devices 25 to indicate the introduction of the players on a team, the performance of the national anthem at a sporting event or any other activity. The centralized operator may also send the activation command to deactivate the novelty devices 25 after the introduction, the performance, or the occurrence of any other event or activity. Alternatively, as noted above, a timer or a computer programmed by software may be used to stop transmission of the activation command, or even to send the activation command to deactivate the novelty devices 25 to the transmitting unit 15 after a specific period of time. For example, the novelty devices 25 may be deactivated after thirty seconds.

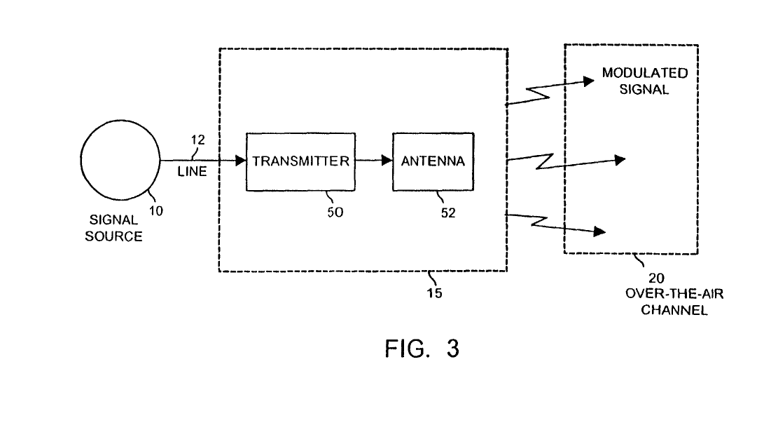

As shown in FIG. 3, the signal source 10 is connected to the transmitting unit 15 through the line 12. The line 12 establishes a connection between the signal source 10 and the transmitting unit 15, and may include, but is not limited to, ISDN lines, T-1 lines, DSL lines, coaxial cable, fiber optics, and wireless, cellular or satellite links. The transmitting unit 15 includes a transmitter 50 coupled to an antenna 52. The transmitting unit 15 communicates with the novelty devices 25 through the over-the-air channel 20.

The signal source 10 provides the activation command through the line 12 to the transmitting unit 15. As noted above, the activation command may be an analog signal, a digital signal, a combined analog-digital signal, a bit-pattern code, or any other desired signal, such as a signal of a specific frequency or channel. For example, the activation command may be a carrier signal, such as the modulated operating signal without carrying the activation command, or a dual-tone multiple frequency (DTMF) tone, such as one generated by a telephone when the keys thereof are pressed. A DTMF tone is the sound emitted when the key numbered “1” or any other of the numbered keys, including the “*” and “#” keys, on a telephone is pressed. Moreover, the activation command may include a series of signals, such as a series of carrier signals or DTMF tones. The transmitter 50 receives the activation command from the signal source 10, and modulates a carrier signal with the activation command to produce a modulated operating signal. For example, the modulated operating signal may carry the activation command in DTMF tone to the novelty devices 25. The transmitter 50 may include, but is not limited to, FCC compliant low power or commercially licensed amplitude modulation (AM), frequency modulation (FM) or subsidiary communications authorization (SCA) transmitters or satellite transmitters. The modulated operating signal is coupled to the antenna 52, which transmits the modulated operating signal through the over-the-air channel 20 to one or more of the novelty devices 25. In this manner, the modulated operating signal, which may include a radio frequency or on any other electromagnetic frequency signal, is sent from the transmitter 50 to the novelty devices 25 via the over-the-air channel 20.

As described above in one embodiment, the transmitter 50 and the antenna 52 are located in the transmitting unit 15. Depending on the cost and the technology available, the signal source 10, the line 12, the transmitter 50, and the antenna 52 may be integrated into a portable transmitting unit to send the modulated operating signal through the over-the-air channel 20 to a plurality of remotely activated novelty devices 25, which may be portable or fixed in nature. In such a configuration, the portable transmitting unit provides the activation command, modulates the activation command to produce the modulated operating signal, and transmits the modulated operating signal through the over-the-air channel 20. In this case, the centralized operator presses a button or a key of the portable transmitting unit to send the modulated operating signal, carrying the activation command through the over-the-air channel 20. The modulated operating signal may be sent at any electromagnetic energy wavelength to one or more remotely activated novelty devices 25 in close proximity such as in a stadium, an arena, a ballpark or any other desired facility.

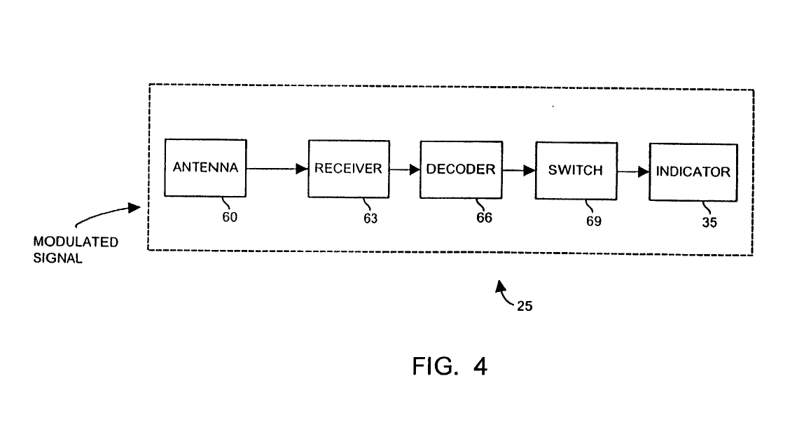

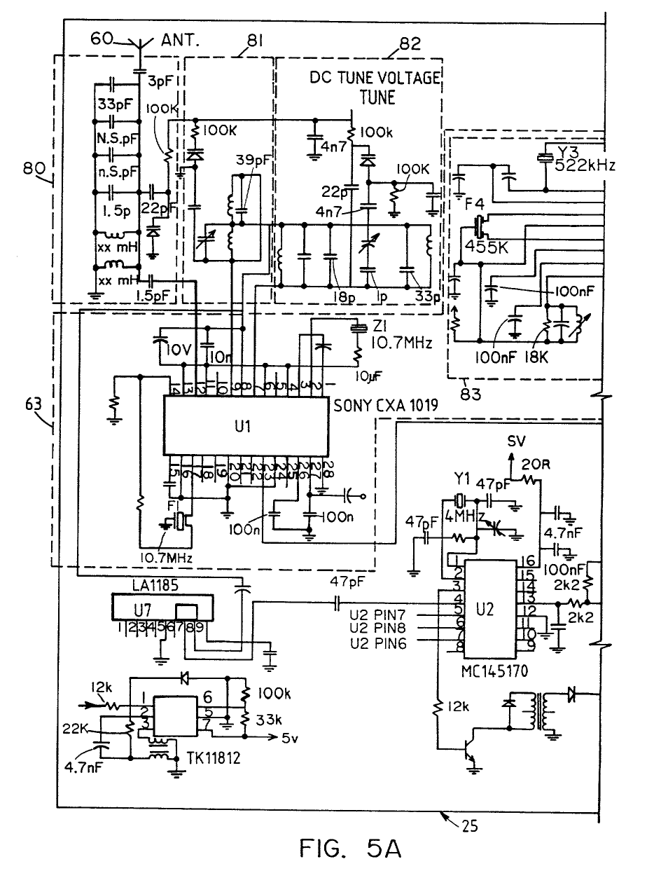

Referring to FIG. 4, the remotely activated novelty device 25 is adapted to respond to the modulated operating signal received via the over-the-air channel 20. The novelty device 25 includes an antenna 60 that receives the modulated operating signal via the over-the-air channel 20, a receiver 63, a decoder 66, a switch 69, and an indicator 35. The antenna 60 couples the received modulated operating signal to the receiver 63, which may include a demodulator to demodulate the modulated operating signal to produce an operating signal. The operating signal is then provided to the decoder 66, which decodes the operating signal to detect the presence or absence of the activation command. When the decoder 66 detects an activation command such as a specific DTMF tone or any other desired signal, the decoder 66 operates the switch 69 to activate the indicator 35, which may be, for example, lights such as LEDs, speakers, mechanical devices, or any other visual or audio indicators. As noted above, the remotely activated novelty device 25 may produce a light, a sound, or mechanical action to indicate an occurrence of an event or an activity, which may be a goal scored at a hockey game, a home run scored at a baseball game, or a touchdown scored at a football game, after receiving the activation command. When the decoder 66 detects the absence of the activation command or the presence of the activation command to deactivate the novelty devices 25, the decoder 66 operates the switch 69 to deactivate the indicator 35. Of course, the novelty devices 25 may respond differently to different activation commands, and may be configured to take different actions based on the different activation commands being received.

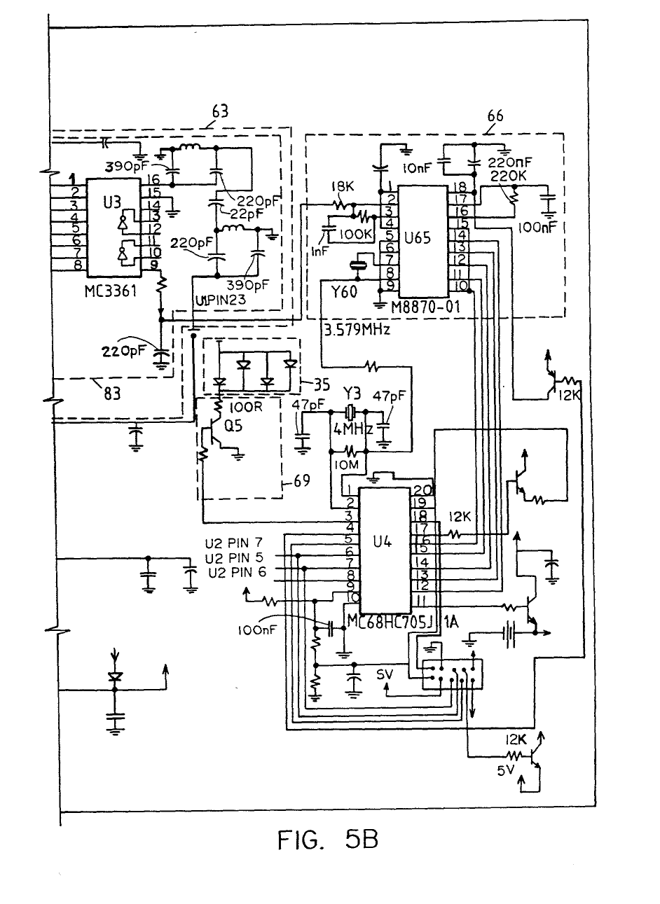

In one embodiment, LEDs or other lights may flash in response to the receipt of an activation command. As shown in FIG. 5, one embodiment of the novelty device 25, which uses a telephone signal as the activation command, generally includes the antenna 60, the receiver 63, the decoder 66, the switch 69 and the indicator 35. As illustrated in FIG. 5, the antenna 60 is coupled to a selective bandpass filter 80, which may be an LC circuit. The bandpass filter 80 is coupled to an RF filter 81, which may be an LC circuit, and the receiver 63, which has two receiver chips, a receiver chip U1 and an SCA narrowband receiver chip U3. The RF filter 81 is connected to an DC tuner 82, which may be an LC circuit, and the receiver chip U1. The DC tuner 82 is coupled to the receiver chip U1 and a synthesizer U2, which is further discussed below. The receiver chip U1, which may be a Sony CXA1019, is connected to a 10.7 MHz crystal Z1 and the synthesizer U2. The output of the receiver chip U1 is coupled to the SCA narrowband receiver chip U3, which may be a Motorola MC3361 Low Power Narrowband FM IF integrated circuit. The SCA narrowband receiver chip U3 is connected to a 455 kHz resonator F4, support circuitry 83, and the decoder 66. The support circuitry 83 of the SCA narrowband receiver chip U3 includes resistors, capacitors, and inductors that, as one of ordinary skill in the art will readily recognize, may be replaced by other discrete components as desired to configure the SCA narrowband receiver chip U3. The decoder 66 includes a telephone DTMF decoder U65, which may be a Teltone M8870-01 integrated circuit. The decoder 66 is coupled to a microcontroller U4, which may be a Motorola MC68H705J1A microcontroller integrated circuit.

The microcontroller U4 is connected to a voltage booster U8, the synthesizer U2, and the switch 69. The voltage booster U8 includes a Toko TK11812 DC-DC converter to supply power to operate the novelty device 25. The synthesizer U2, which may be a Motorola MC145170 phase-locked loop (PLL) frequency synthesizer, is connected to discrete components, which include resistors, capacitors and a 4 MHz crystal Y1, and a low-cost buffer U7, which may be a Sanyo LA1185 buffer device. As mentioned above, the synthesizer U2 is coupled to the DC tuner 82 and the receiver chip U1, which is located in the receiver 63. The switch 69 includes a transistor Q5, which may be a Motorola FMMT4401CT high current NPN transistor. The indicator 35 includes four LEDs coupled in parallel to the switch 69. While some of the individual circuit component types are indicated in FIG. 5, one of ordinary skill in the art will readily recognize that other types of components may be chosen. However, various portions of FIG. 5 have been particularized to show the actual electrical components that embody the elements reflected in FIG. 4.

In the embodiment of FIG. 5, the microcontroller U4 controls the operation of activating the indicator 35 in the novelty device 25 to indicate an occurrence of an event or an activity. The voltage booster U8 supplies five volts to operate the microcontroller U4. During operation, the microcontroller U4 provides, to the synthesizer U2, the input frequencies to which the synthesizer U2 is to tune to receive the modulated operating signal via the over-the-air channel 20. The microcontroller U4 also operates the switch 69 to activate or deactivate the indicator 35 after receiving the appropriate activation command extracted from the operating signal by the telephone DTMF decoder U65, which is further discussed below.

The novelty device 25 receives the modulated operating signal through the antenna 60. The modulated operating signal passes through the selective bandpass filter 80 and the RF filter 81 configured as LC circuits, which tune to the frequency specified by the synthesizer U2 and the DC tuner 82. The buffer U7 increases the signal strength of the PLL output signal from the synthesizer U2.

The output of the bandpass filter 80 is delivered to the receiver 63, which includes the receiver chip U1 and the SCA narrowband receiver chip U3, to down-convert the modulated operating signal sent from the transmitting unit 15. The modulated operating signal passes through the receiver chip U1, which down-converts the modulated operating signal to produce an output signal centered at 10.7 MHz. The output of the receiver chip U1 is coupled to the SCA narrowband receiver chip U3. The SCA narrowband receiver chip U3 further down-converts the modulated operating signal from the receiver chip U1 to produce an output signal centered at 455 kHz. The output of the SCA narrowband receiver chip U3 is an operating signal that may be decoded by the telephone DTMF decoder U65.

The telephone DTMF decoder U65 decodes the operating signal to extract the activation command. As mentioned above, the activation command may be a specific DTMF tone or any other desired signal. In this configuration, the activation command is a DTMF tone. When the telephone DTMF decoder U65 detects the presence of any DTMF tone in the operating signal, the telephone DTMF decoder U65 sends an indication of that DTMF tone in a 4-bit code to the microcontroller U4. For example, if the DTMF tone is five, then the telephone DTMF decoder U65 may send a 0101 bit-pattern code to the microcontroller U4 to operate the switch 69. The microcontroller U4, which is programmed to recognize the bit-pattern code for the twelve different DTMF tone, determines whether to operate the switch 69 to activate the indicator 35 based on whether the received tone is designated as an activation command. The twelve different DTMF tones may activate the novelty device 25 to perform different actions. For example, the DTMF tone associated with the key numbered “1” on a telephone may activate the indicator 35 to cause the LEDs to flash, the DTMF tone associated with the key numbered “2” may activate the indicator 35 to come on and stay on to flash in a different manner, etc. As noted above, activation command may also deactivate the novelty devices 25. For example, the DTMF tone associated with the key numbered “0” may deactivate the indicator 35 to turn off the LEDs.

The switch 69, which is controlled by the microcontroller U4, operates to activate the indicator 35. As noted above, the indicator 35 may include, but not limited to, LEDs, speakers, or mechanical devices. In the embodiment shown in FIG. 5, the indicator 35 includes four LEDs connected in parallel to the switch 69. When the switch 69 is activated by the microcontroller U4, the LEDs will cause display lights to activate.

As mentioned above, the indicator 35 may be activated by the activation command for a specific period of time. Accordingly, the indicator 35 may be deactivated by a timer, an activation command to deactivate that is sent by the centralized operator, or both. The microprocessor U4 may receive a bit-pattern code that represents the absence of the activation command from the decoder 66, and deactivate the indicator 35. The microprocessor U4 may also operate the switch 69 to deactivate the indicator 35 after a specific period of time. Alternatively, the centralized operator, such as an announcer, a stage manager, a viewer from home, etc., may send an activation command to deactivate the novelty device 25.

While the embodiment illustrated in FIG. 5 may perform actions as described above, other embodiments of the novelty device 25 may perform different actions based on the different DTMF tones. As indicated above, for example, pressing the key numbered “1” may activate the indicator 35, and pressing the key numbered “0” may deactivate the indicator 35. Thus, the numbered keys, including the “*” and “#” keys, on a telephone may be pressed to activate the novelty device 25 to indicate that a player scored a goal, a run, or a touchdown at a sporting event. For instance, if the player who wears the jersey number “13” and scores a touchdown, then the keys numbered “1” and “3” may be pressed to activate the novelty device 25 to display “13.” Alternatively, the different DTMF tones may also activate a plurality of novelty devices 25 located at different places to indicate occurrences of a plurality of events. In this case, the activation command may be sent by establishing a telephone connection between the operator and the transmitting unit 15 and pressing the key numbered “2” on a telephone to activate a plurality of novelty devices 25 located at a football game on the south side of town to indicate a touchdown scored. The key numbered “3” may be pressed on the same telephone to activate a plurality of novelty devices 25 located at a baseball game on the north side of town to indicate a home run scored. Moreover, the key numbered “4” may be pressed to activate a plurality of novelty devices 25 located at a hockey game on the west side of town to indicate a goal scored. Alternatively, the numbered keys on a computer keyboard connected to a computer programmed to provide the activation command may be used to produce the different DTMF tones to activate the novelty device 25 to perform the actions mentioned above or any other different actions. The centralized operator may be, but is not limited to, any human operator located at any desired location or a computer programmed by software to send the activation command to deactivate the indicator 35 after a specific period of time. The novelty device 25 may be modified in numerous ways and may have many alternative embodiments. For example, the microcontroller U4 may be replaced with a masked microcontroller such as a Motorola MC68HC05J1A masked microcontroller, a higher-end processor such as a Motorola MC68HC11 microprocessor or any other generally programmed or programmable microcontroller or microprocessor. Parts such as the telephone DTMF decoder U65 may also be integrated into a controller or a processor. As noted above, other circuit components can be used in addition to or in replacement of the circuit components shown in FIG. 5. Further, the microcontroller U4 as shown in FIG. 5 is not absolutely necessary to the operation of this embodiment of the novelty device 25. Alternatively, the microcontroller U4 may be replaced by an application specific integrated circuit (ASIC). For example, the synthesizer U2 may be hardwired to the specified PLL frequency and the output of the telephone DTMF decoder U65 may be coupled directly to the switch 69 without a microcontroller or a microprocessor to operate the novelty device 25. Moreover, the novelty device 25 may include any desired receiver, decoder, switch or indicator other than the parts specifically described herein.

Numerous modifications and alternative embodiments of the invention will be apparent to those skilled in the art in view of the foregoing description. Accordingly, this description is to be construed as illustrative only and not as limiting to the scope of the invention. The details of the structure may be varied substantially without departing from the spirit of the invention, and the exclusive use of all modifications, which are within the scope of the appended claims, is reserved.

It is claimed:

1. A remotely activated novelty device adapted to respond to an operating signal received via an over-the-air channel, the device comprising:
an antenna that receives the operating signal;
a receiver coupled to the antenna;
a decoder that decodes the operating signal to detect the presence of an activation command;
a switch coupled to the decoder; and
an indicator coupled to the switch;
wherein the decoder operates the switch to activate the indicator when the decoder detects the presence of the activation command.

2. The device of claim 1, wherein the antenna receives a modulated operating signal including the operating signal, and wherein the receiver further includes a demodulator that demodulates the modulated operating signal to retrieve the operating signal.

3. The device of claim 1, wherein the decoder includes a dual-tone multiple frequency decoder.

4. The device of claim 1, wherein the indicator includes a light emitting diode.

5. The device of claim 1, wherein the indicator includes a speaker.

6. A system for remotely activating a novelty device comprising:
a signal source that provides an activation command;
a transmitter that modulates the activation command to produce an operating signal;
an antenna coupled to the transmitter to transmit an operating signal through an over-the-air channel; and
a plurality of novelty devices, each novelty device including:
an antenna that receives the operating signal via an over-the-air channel;
a receiver coupled to the antenna;
a decoder that decodes the operating signal to detect the presence of an activation command;
a switch coupled to the decoder; and
an indicator coupled to the switch;
wherein the decoder operates the switch to activate the indicator when the decoder detects the presence of the activation command.

7. The system of claim 6, wherein the signal source includes a phone.

8. The system of claim 6, wherein the antenna receives a modulated operating signal including the operating signal, and wherein the receiver further includes a demodulator that demodulates the modulated operating signal to retrieve the operating signal.

9. The system of claim 6, wherein the decoder includes a dual-tone multiple frequency decoder.

10. The system of claim 6, wherein the indicator includes a light emitting diode.

11. The system of claim 6, wherein the indicator includes a speaker.

12. A method for remotely activating a novelty device, including the steps of:
providing an activation command;
transmitting an operating signal through an over-the-air channel;
receiving the operating signal via the over-the-air channel;
decoding the operating signal to detect the presence of the activation command; and
operating a switch to activate an indicator when the decoder detects the presence of the activation command.

13. The method of claim 12, further comprising the step of modulating the activation command to produce a modulated operating signal.

14. The method of claim 12, further comprising the step of demodulating the modulated operating signal to produce the operating signal.

15. The method of claim 12, wherein the step of decoding the operating signal includes step of decoding the operating signal to detect the presence of a dual-tone multiple frequency tone.

16. The method of claim 15, wherein the step of operating a switch to activate the indicator includes the step of operating a switch to activate the indicator when the decoder detects the presence of the dual-tone multiple frequency tone.

17. A method for promoting a company, comprising the steps of:
distributing a plurality of remotely activated novelty devices;
providing an activation command after an occurrence of an event or an activity;
transmitting an operating signal through an over-the-air channel;
receiving the operating signal via the over-the-air channel;
decoding the operating signal to detect the presence of the activation command; and
operating a switch to activate an indicator when the decoder detects the presence of the activation command.

18. The method of claim 17, further comprising the step of modulating the activation command to produce a modulated operating signal.

19. The method of claim 17, further comprising the step of demodulating the modulated operating signal to produce the operating signal.

20. The method of claim 17, wherein the step of decoding the operating signal includes the step of decoding the operating signal to detect the presence of a dual-tone multiple frequency tone.

21. The method of claim 20, wherein the step of operating a switch to activate the indicator includes the step of operating a switch to activate the indicator when the decoder detects the presence of the dual-tone multiple frequency tone.
